(19) United States
(12) Patent Application Publication
(10) Pub. No.: US 2012/0054767 A1
(43) Pub. Date: Mar. 1, 2012

(54) RECORDING MEDIUM FOR RESOURCE MANAGEMENT PROGRAM, RESOURCE MANAGEMENT DEVICE, AND RESOURCE MANAGEMENT METHOD

(75) Inventors: Yasunari TATEIWA, Kawasaki (JP); Tsutomu Enokida, Kawasaki (JP)

(73) Assignee: FUJITSU LIMITED, Kawasaki (JP)

(21) Appl. No.: 13/211,567

(22) Filed: Aug. 17, 2011

(30) Foreign Application Priority Data
Aug. 30, 2010 (JP) 2010-192815

(51) Int. Cl. G06F 9/50

(52) U.S. Cl. 718/104

(57) ABSTRACT

A computer-readable, non-transitory medium storing a program causing a computer to execute a process, the process including: assigning, to a thread, a processing that is specified by a program described with a procedural language and requested by a received processing request; reading out the thread resource stored with being associated with identification information for identifying a session used for communication relating to the processing request, from a storage unit in which identification information for identifying a session and the thread resource are stored with being associated with each other; and executing the processing assigned to the thread by using the read out thread resource.

### CROSS-REFERENCE TO RELATED APPLICATION

This application is based upon and claims the benefit of priority of the prior Japanese Patent Application No. 2010-192815, filed on Aug. 30, 2010, the entire contents of which are incorporated herein by reference.

### FIELD

The present invention relates to a recording medium for a resource management program, a resource management device, and a resource management method.

### BACKGROUND

Usually, in backbone systems which are applied to mission-critical tasks of enterprises, such as inventory management, financial affairs, and the like, a large number of server applications have been developed by using common business oriented languages (COBOL). Furthermore, in recent years, operations in which clients of Java (registered trademark) applications call procedural COBOL applications on server sides have been more common in Web applications.

For example, a technique has been known in which a general-purpose Java Servlet automatically generates a telegram used for calling a COBOL application under the control of a transaction processing system, on the basis of a user interface XML source in response to a request from a Web browser, receives, as a telegram, a result processed by the transaction processing system, generates an HTML to be used for causing the received telegram to be displayed on a Web browser on the basis of the user interface XML source, and sends back the HTML as a response for the request from the Web browser. An example of such a technique is disclosed in Japanese Laid-open Patent Publication No. 2001-509286.

However, in a server of the related art, even if a plurality of continued requests are received, it is not necessarily possible to execute the processing of procedural applications corresponding to the plural requests, on a same thread. As a result, in the server of the related art, it is difficult to take over a same thread resource between continued requests when a procedural application is executed with respect to each request.

### SUMMARY

According to an aspect of the embodiments, a computer-readable, non-transitory medium storing a program causing a computer to execute a process, the process including: assigning, to a thread, a processing that is specified by a program described with a procedural language and requested by a received processing request; reading out the thread resource stored with being associated with identification information for identifying a session used for communication relating to the processing request, from a storage unit in which identification information for identifying a session and the thread resource are stored with being associated with each other; and executing the processing assigned to the thread by using the read out thread resource.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an internal configuration of a server device according to a first embodiment;

FIG. 2 is an explanatory diagram illustrating a utilization form of a Web service application according to a second embodiment;

FIG. 3 is an explanatory diagram illustrating an internal configuration of a server device for a Web service application;

FIG. 4 is an explanatory diagram illustrating in detail a table configuration within a resource management unit;

FIG. 5 is an explanatory diagram illustrating an operation of the server device for the Web service;

FIG. 6 is a flowchart illustrating a processing operation of the server device for the Web service;

FIG. 7 is a flowchart illustrating a processing operation of a Web service application;

FIG. 8 is a flowchart illustrating a processing operation of a procedural COBOL application;

FIG. 9 is a flowchart illustrating a processing operation of an RTS (Run Time System);

FIG. 10 is an explanatory diagram illustrating a computer executing a resource management program;

FIG. 11 is an explanatory diagram illustrating a utilization form of a Web application;

FIG. 12 is an explanatory diagram illustrating a utilization form of a Web application for a multi-thread method; and

FIG. 13 is an explanatory diagram illustrating a utilization form of a Web service application.

### DESCRIPTION OF EMBODIMENTS

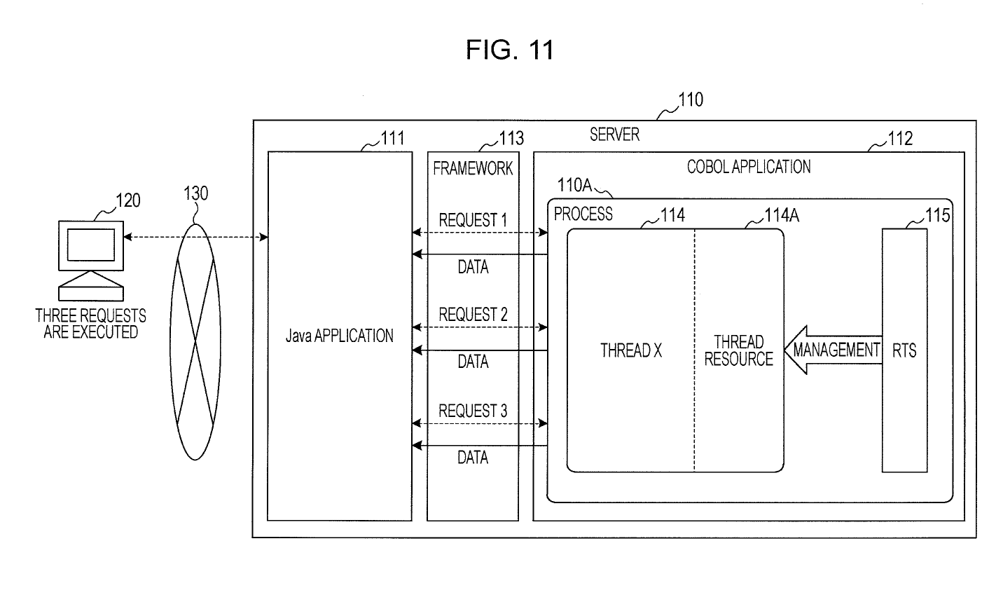

Before an embodiment of the present invention is described, a Web application having a form in which a Java application calls a procedural COBOL application will be described using FIG. 11 to FIG. 13.

FIG. 11 illustrates the structure of software executed by a Web application-use server device (hereinafter, simply referred to as “server”) 110. In the server 110, in response to a request via Internet 130 from a Web browser 120, a COBOL application 112 is executed. Furthermore, a Java application 111 in the server 110 receives a request from the Web browser 120 through the Internet 130.

A framework 113 within the server 110 is software including a function for converting a request of the Java application 111 into a request of the COBOL application 112. Furthermore, when having received the request converted in the framework 113, the COBOL application 112 in the server 110 executes a single thread 114 and a COBOL Run Time System (hereinafter, simply referred to as “RTS”) 115 on a process 110A. In addition, the RTS 115 creates a thread resource 114A to be used by the COBOL application 112 on the thread 114, and provides the thread resource 114A to the COBOL application 112 on the thread 114.

The thread resource 114A includes data, a usage file, a DB connection, and the like. As an exemplification, when the procedural COBOL application 112 is a program used for creating an address list on the basis of address data, the data of the thread resource 114A is data or the like that specifies storage positions and reading positions of a zip code, an address, a phone number, and the like, the usage file is a file in which pieces of address data such as a zip code, an address, a phone number, and the like are enumerated, and the DB connection may be information relating to a connection to a DB in which the usage file is stored.

In processing based on a program described with a procedural language, described instructions are sequentially executed, and the content of a variable is changed in response to the result of the processing. When there are a plurality of processing requests, the content of a variable may be changed between the plural requests, and hence it is necessary to take over the thread resource 114A.

In the thread 114 on the process 110A, in response to a request from the Web browser 120, the COBOL application 112 is sequentially executed using the thread resource 114A acquired from the RTS 115. In addition, the thread resource 114A used by the COBOL application 112 is managed in units of threads. Accordingly, when the same thread resource 114A is taken over between continued requests, it is necessary to execute a COBOL application relating to all requests on the same thread 114. In the server 110, since the same thread resource 114A is taken over between the continued requests, a single thread method is adopted in which the COBOL application 112 relating to all requests is executed on the single thread 114.

However, since, in the operation form of the server 110, it is necessary to accept requests from the plural Web browsers 120 through the Internet 130, it is usual that a multi-thread method is adopted in which the plural threads 114 are executed on the process 110A.

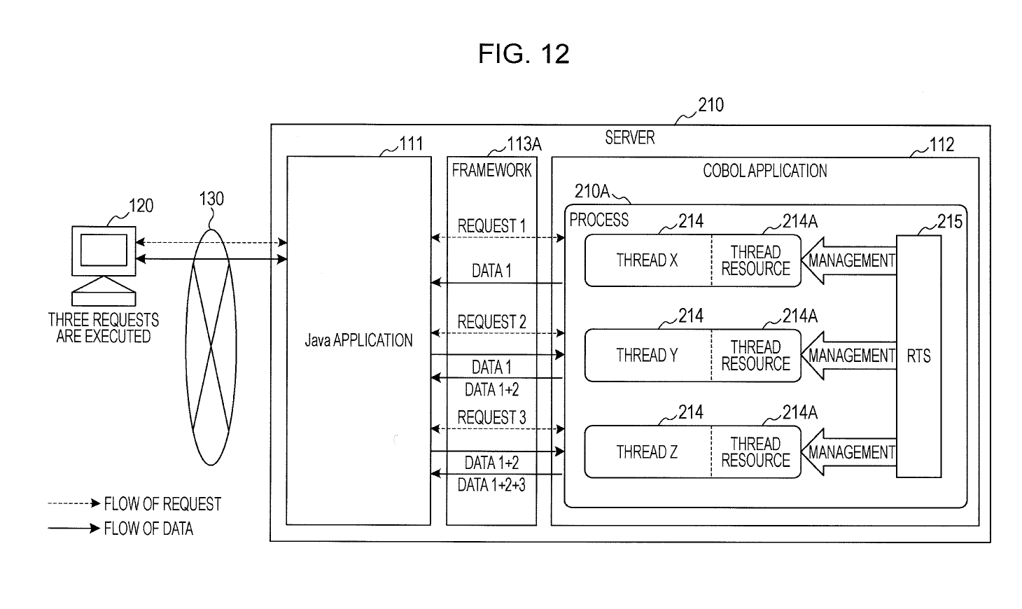

As a system in which the multi-thread method is adopted, there is a system in which data that is a portion of a thread resource is taken over between continued requests and the data taken over is held on a client side or a server side. FIG. 12 is a diagram illustrating the structure of software executed by a server 210. In addition, the same symbol is assigned to the same configuration as that of the utilization form illustrated in FIG. 11, and hence the redundant descriptions of the configuration and the operation thereof will be omitted.

The server 210 illustrated in FIG. 12 adopts a multi-thread method in which a plurality of threads 214 are executed on a process 210A. Furthermore, when having received a request from the Web browser 120 through the Java application 111, a framework 113A assigns the thread 214 on which the COBOL application 112 corresponding to the request is executed, from among the plural threads 214. In addition, an RTS 215 creates a thread resource 214A available to the COBOL application 112 on the thread 214, and provides the thread resource 214A to the thread 214 in which the COBOL application 112 is executed.

When a request “1” from the Web browser 130 is received, the framework 113A assigns a thread “X” in which the COBOL application 112 is executed, for example. Furthermore, the RTS 215 creates the thread resource 214A to be used in the COBOL application 112 on the thread “X”, and provides the thread resource 214A to the COBOL application 112 on the thread “X”.

Furthermore, using the thread resource 214A, the COBOL application 112 on the thread “X” executes processing relating to the request “1”, obtains data “1”, and updates the thread resource 214A, including the data “1”. In addition, the COBOL application 112 transmits the data “1” from among the thread resource 214A to the Web browser 120 through the Java application 111.

Next, when requesting a request “2” subsequent to the request “1”, the Web browser 120 transmits the data “1” to the framework 113A through the Java application 111, in addition to the data “2”. When the framework 113A has received the data “2” and the data “1” form the Web browser 120, the framework 113A assigns a thread “Y” in which the COBOL application 112 is executed, for example.

Furthermore, the RTS 215 creates the thread resource 214A to be used in the COBOL application 112 on the thread “Y”, and provides the thread resource 214A to the COBOL application 112 on the thread “Y”. The COBOL application 112 on the thread “Y” sets the data “1” included in the response of the continued request “1”, in the thread resource 214A. Namely, the data “1” obtained owing to the request “1” turns out to be also taken over by the request “2”.

When, using the thread resource 214A that includes the data “1”, the COBOL application 112 on the thread “Y” executes processing relating to the request “2”, the COBOL application 112 on the thread “Y” obtains the data “2” of the request “2”. In addition, the COBOL application 112 updates the thread resource 214A, including the data “2”. In addition, the COBOL application 112 transmits this time's data “2” and the last data “1” to the Web browser 120 through the Java application 111.

Next, when requesting a request “3” subsequent to the request “2”, the Web browser 120 transmits, to the framework 113A, the last data “1” but one and the last data “2” through the Java application 111, in addition to the request “3”. When having received the request “3”, the data “1”, and the data “2” from the Web browser 120, the framework 113A assigns a thread “Z” in which the COBOL application 112 is executed, for example.

Furthermore, the RTS 215 creates the thread resource 214A to be used in the COBOL application 112 on the thread “Z”, and provides the thread resource 214A to the COBOL application 112 on the thread “Z”. The COBOL application 112 on the thread “Z” sets the last data “1” but one and the last data “2” in the thread resource 214A. Namely, the pieces of data “1” and “2” obtained owing to the request “1” and the request “2” turn out to be also taken over by the request “3”.

When, using the thread resource 214A that includes the data “1” and data “2”, the COBOL application 112 on the thread “Z” executes processing relating to the request “3”, the COBOL application 112 on the thread “Z” obtains the data “3” of the request “3”. In addition, the COBOL application 112 updates the thread resource 214A, including the data “3”. In addition, the COBOL application 112 transmits this time's data “3”, the last data “2”, and the last data “1” but one to the Web browser 120 through the Java application 111.

In the server 210, while only data that is a portion of the thread resource 214A is taken over between continued requests, it is difficult to take over the same thread resource 214A.

Furthermore, in the utilization form of the Web application in the server 210, the amount of data increases with an increase in the number of executions of continued requests, and a communication load on a network between the Java application 111 and the COBOL application 112 becomes large. In the same way, in the utilization form of the Web application, a communication load on a network between the Java application 111 and the Web browser 120 also becomes large. Namely, in the utilization form of the Web application, while it is possible to take over the data that is a portion of the thread resource 214A between continued requests, a communication load on a network increases in response to an increase in the number of executions of continued requests.

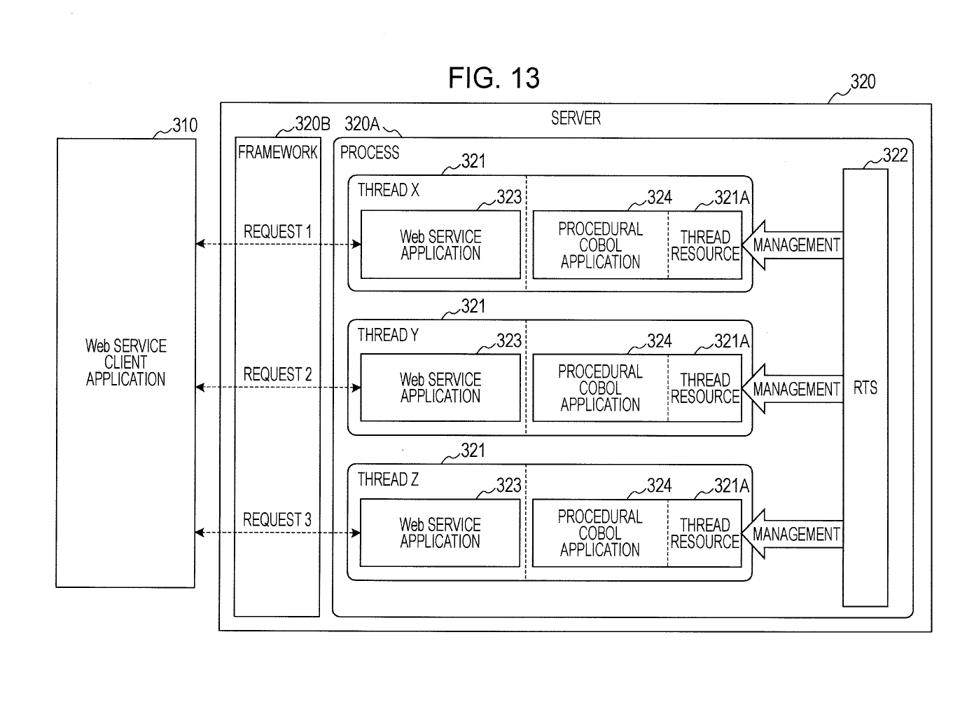

In addition, in recent years, Web service applications have widely spread in which it is possible to execute Web applications with no Web browser. FIG. 13 illustrates the software configuration of a Web service application-use server 320 (hereinafter, simply referred to as “server 320”). In the server 320, using a multi-thread method, a procedural COBOL application 324 is executed in response to a request from a Web service client application 310. In addition, the Web service client application 310 is not limited to an application embedded in a client terminal facing the server 320, and corresponds to an application in a sense that the application faces the server 320.

When having received a request from the Web service client application 310, a framework 320B in the server 320 assigns a thread 321 to be executed by a Web service application 323 on a server side, from among a plurality of threads 321 executed on a process 320A.

The Web service application 323 calls the procedural COBOL application 324 onto the same thread 321. Furthermore, the procedural COBOL application 324 requests an RTS 322 to create a thread resource 321A to be used. In addition, the RTS 322 creates the thread resource 321A in response to the resource creation request, and provides the thread resource 321A to the procedural COBOL application 324.

In the utilization form illustrated in FIG. 13, in response to a request from the Web service client application 310, the procedural COBOL application 324 on the server 320 side is executed.

However, in the above-mentioned server 320, even if a plurality of continued requests are received from the Web service client application 310, it is not necessarily possible to execute the COBOL application 324 on the same thread 321 with respect to each request. As a result, in the above-mentioned server 320, when the COBOL application 324 is executed with respect to each request, it is difficult to take over the same thread resource 321A between continued requests.

In addition, while it is considered that the method in FIG. 11, in which data, which is a portion of the thread resource, is taken over between continued requests, is adopted for the server 320, a network load between the client and the server increases in response to an increase in the number of executions of continued requests. Furthermore, in that case, a resource taken over between continued requests is just a portion of a thread resource, and the thread resource itself is not taken over.

Hereinafter, embodiments of a recording medium for a resource management program, a resource management device, and a resource management method, disclosed in the present application, will be described in detail on the basis of figures. In addition, it should be understood that a disclosed technique is not limited owing to the embodiments.

### First Embodiment

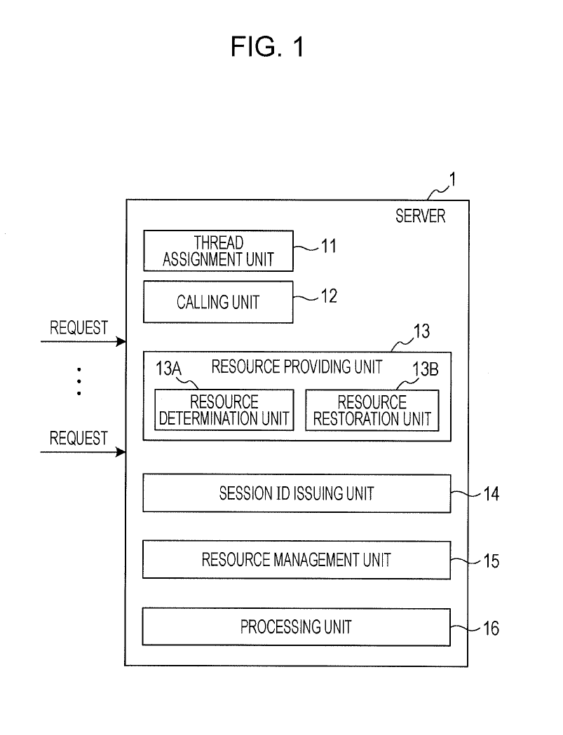

FIG. 1 is an explanatory diagram illustrating the internal configuration of a server device (hereinafter, simply referred to as “server”) according to a first embodiment. A server 1 may adopt a multi-thread method in which a plurality of threads are executed. The server 1 includes a thread assignment unit 11, a calling unit 12, a resource providing unit 13, a session ID issuing unit 14, a resource management unit 15, and a processing unit 16.

When having received a request, the thread assignment unit 11 assigns, to the processing unit 16, a thread in which processing requested by the request is executed. The calling unit 12 calls, onto the same thread, an application requested by the request and described with a procedural language.

In response to a resource request from the application, the resource providing unit 13 provides a resource used by the application to the application on the thread. The session ID issuing unit 14 issues a session ID used for identifying a session that has been used for the received request. The session ID issuing unit 14 issues a session ID in response to determination of the resource determination unit 13A.

Using the resource provided by the resource providing unit 13, the processing unit 16 executes the application called by the calling unit 12, in the thread assigned by the thread assignment unit 11. When the server 1 adopts the multi-thread method, it is possible for the thread assignment unit 11 to assign a plurality of threads to the processing unit 16.

When the execution processing of the application on the thread is completed, the resource management unit 15 causes the resource used by the application to retreat from the thread. Furthermore, the resource management unit 15 manages the resource caused to retreat, with associating the resource with the session ID used for identifying the session that has been used for the request.

The resource providing unit 13 includes a resource determination unit 13A and a resource restoration unit 13B. When the resource is provided to the application, the resource determination unit 13A determines whether or not a resource corresponding to the session ID exists in the resource management unit 15 when having received the session ID of the session that has been used for the request. When the resource determination unit 13A determines that the resource corresponding to the session ID exists, the resource restoration unit 13B restores the corresponding resource onto the application relating to the request. When the resource determination unit 13A determines that the resource corresponding to the session ID does not exist in the resource management unit 15, the resource restoration unit 13B causes the session ID issuing unit 14 to issue a session ID.

In the first embodiment, even if a request is received in each of a plurality of sessions, it is possible to manage a resource using, as a key, the session ID of a session used by the request, and take over the same resource between continued requests.

### Second Embodiment

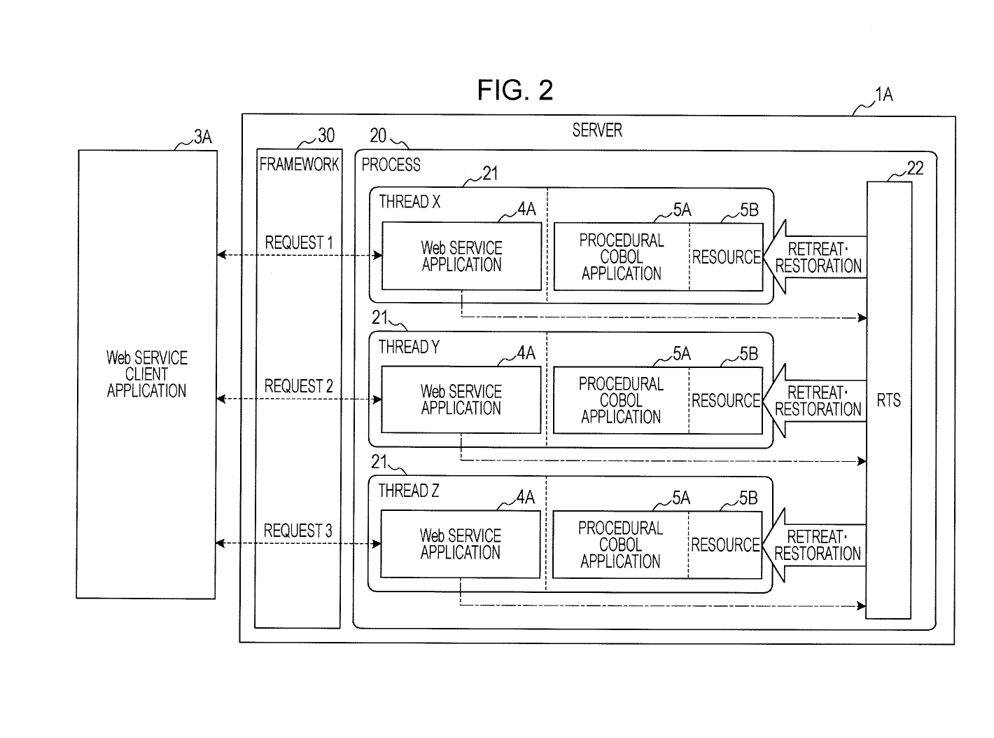

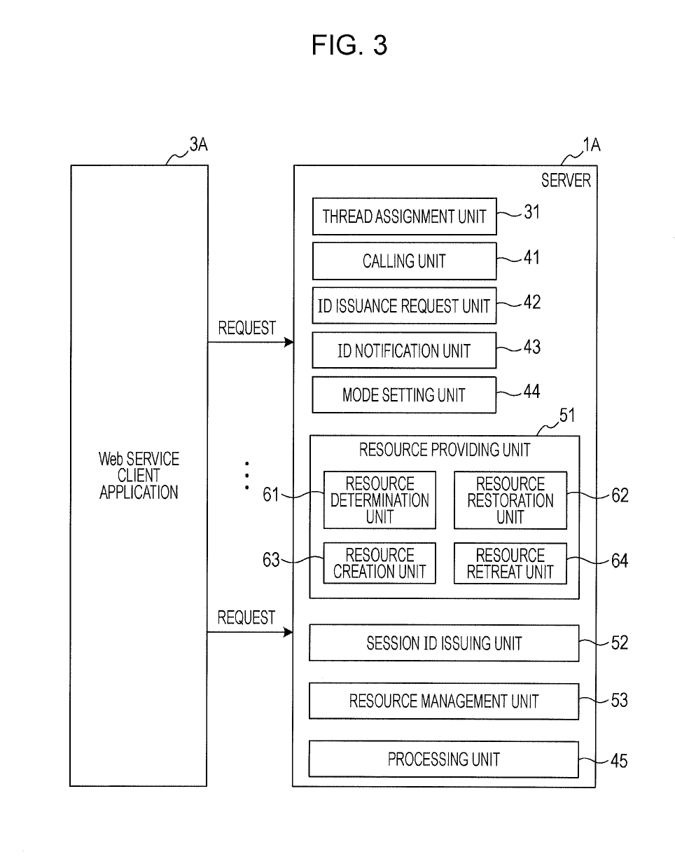

FIG. 2 is an explanatory diagram illustrating the utilization form of a Web service application according to a second embodiment. FIG. 3 is an explanatory diagram illustrating the internal configuration of a server device for a Web service application according to the second embodiment. The server device (hereinafter, simply referred to as “server”) 1A for the Web service application illustrated in FIG. 2 accepts a request for a procedural COBOL application 5A from a Web service client application 3A through the Web service application 4A.

On a process 20 in the server 1A illustrated in FIG. 2, a plurality of threads 21 and an RTS 22 are executed. The server 1A illustrated in FIG. 3 includes a thread assignment unit 31, a COBOL calling unit 41, an ID issuance request unit 42, an ID notification unit 43, a mode setting unit 44, and a processing unit 45. When having received a request from the Web service client application 3A, the thread assignment unit 31 assigns, to the processing unit 45, processing requested by the request, for example, the thread 21 executed by the Web service application 4A, from among the plural threads 21.

The COBOL calling unit 41 calls the procedural COBOL application 5A requested by the request, onto the same thread 21 executed by the Web service application 4A. The ID issuance request unit 42 requests the RTS 22 to issue a session ID for identifying a session used by the request. In addition, the session corresponds to a session that has been used for the request between the Web service client application 3A and the Web service application 4A. In addition, when the execution of the procedural COBOL application 5A on the same thread 21 is completed, the ID issuance request unit 42 requests the RTS 22 to update the session ID used for the request.

The ID notification unit 43 notifies the Web service client application 3A or the RTS 22 of the session ID. The mode setting unit 44 sets a normal mode in which a thread resource is used as a resource 5B used by the COBOL application 5A or an EXTERNAL mode in which an EXTERNAL resource is used as the resource 5B used by the COBOL application 5A.

In addition, the server 1A includes a resource providing unit 51, a session ID issuing unit 52, and a resource management unit 53. The resource providing unit 51 provides the resource 5B to the COBOL application 5A in response to a resource request from the procedural COBOL application 5A executed on the thread 21. When having received an ID issuance request from the ID issuance request unit 42 of the Web service application 4A executed on the thread 21, the session ID issuing unit 52 issues a session ID used for identifying the session that has been used for the request. When having received an update request of the ID issuance request unit 42, the session ID issuing unit 52 updates the corresponding session ID, and re-notifies the Web service application 4A of the session ID.

The resource management unit 53 manages the resource 5B used for the procedural COBOL application 5A relating to the corresponding request, with associating the resource 5B with the session ID used for identifying the session that has been used for the request. In addition, the resource 5B corresponds to the thread resource or the EXTERNAL resource. In addition, using the resource 5B provided by the resource providing unit 51, the processing unit 45 executes the procedural COBOL application 5A called by the COBOL calling unit 41, in the thread 21 assigned by the thread assignment unit 31. When the server 1A adopts the multi-thread method, the thread assignment unit 31 can assign the plural threads 21 to the processing unit 45.

In addition, the resource providing unit 51 includes a resource determination unit 61, a resource restoration unit 62, a resource creation unit 63, and a resource retreat unit 64. When having received the session ID of a session used by a request in providing the resource 5B in response to a resource request from procedural COBOL application 5A, the resource determination unit 61 determines whether or not a resource corresponding to the session ID exists in the resource management unit 53.

When the resource determination unit 61 determines that the resource corresponding to the session ID exists, the resource restoration unit 62 restores the resource for the procedural COBOL application 5A relating to the request. When the resource determination unit 61 determines that the resource corresponding to the session ID does not exist, the resource creation unit 63 creates a new resource for the procedural COBOL application 5A relating to the request. When the execution processing of the procedural COBOL application 5A on the thread 21 is completed, the resource retreat unit 64 retreats the resource used by the procedural COBOL application 5A from the procedural COBOL application 5A. Furthermore, the resource retreat unit 64 manages the retreated resource in the resource management unit 53, with associating the resource with the session ID.

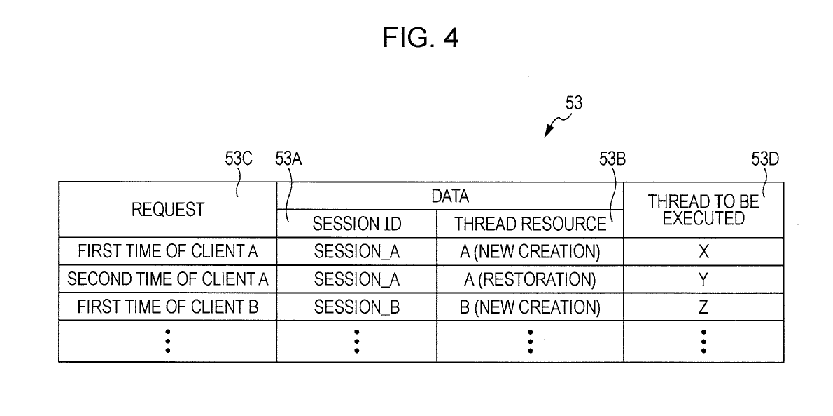

FIG. 4 is an explanatory diagram illustrating in detail a table configuration within the resource management unit 53. The resource management unit 53 manages a session ID 53A, a resource 53B, and an execution thread 53D with respect to each request 53C. With respect to a first request of a client A, by referring the resource management unit 53, the RTS 22 recognizes that the session ID is a “SESSION A”, the resource 53B is the new creation of a thread resource “A”, and the execution thread is “X”. In addition, with respect to a second request of the client A, the RTS 22 recognizes that the session ID is the “SESSION A”, the resource 53B is the restoration of the thread resource “A”, and the execution thread is “Y”.

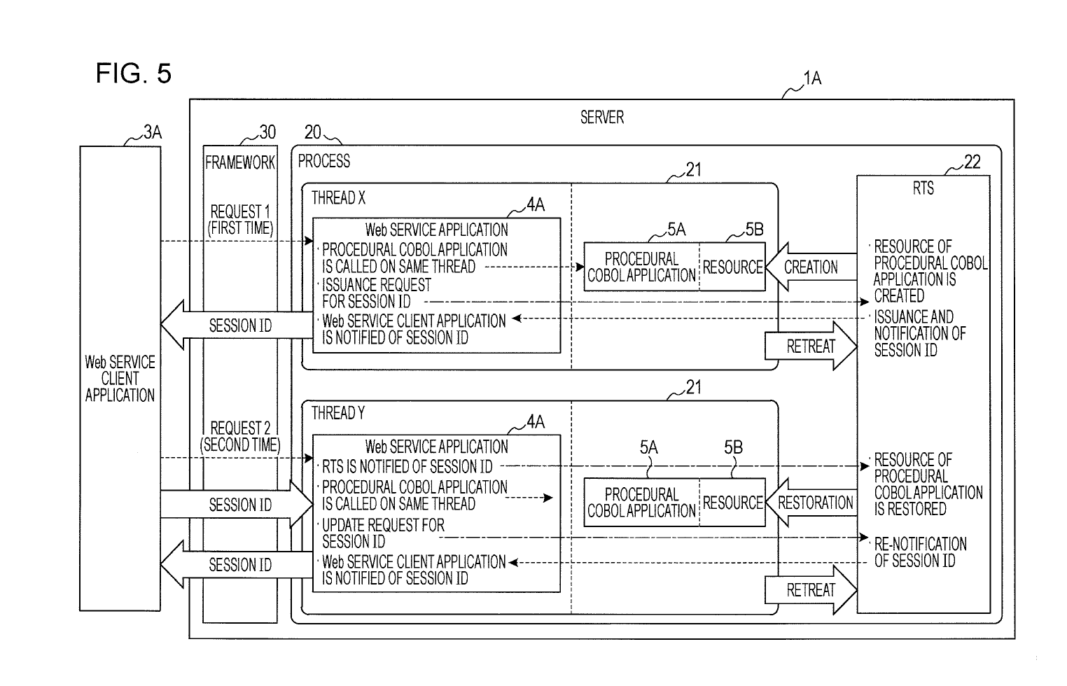

Next, the operation of the server 1A according to the second embodiment 2 will be described. FIG. 5 is an explanatory diagram illustrating the operation of the server 1A. In addition, for example, the Web service application 4A utilizes the COBOL calling unit 41, the ID issuance request unit 42, the ID notification unit 43, and the mode setting unit 44. Furthermore, for example, the RTS 22 utilizes the resource providing unit 51, the session ID issuing unit 52, and the resource management unit 53. When having received a first request “1” from the Web service client application 3A, a framework 30 in the server 1A illustrated in FIG. 5 assigns a thread 21 “X” in which the Web service application 4A is executed. The Web service application 4A calls the procedural COBOL application 5A onto the same thread 21 “X”. The procedural COBOL application 5A acquires the resource 5B to be used, from the RTS 22.

Furthermore, when the execution of the procedural COBOL application 5A on the same thread 21 “X” is completed, the Web service application 4A notifies the RTS 22 of an issuance request for a session ID used for identifying the session of the first request “1”. The RTS 22 issues the session ID, and notifies the Web service application 4A of the session ID. Furthermore, the RTS 22 retreats the resource 5B of the procedural COBOL application 5A on the thread 21 “X”. Furthermore, when having received the session ID, the Web service application 4A notifies the Web service client application 3A of the session ID.

Next, when having received a second request “2” and a session ID from the Web service client application 3A, the framework 30 assigns a thread 21 “Y” in which the Web service application 4A is executed. When having received the session ID from the Web service client application 3A, Web service application 4A notifies the RTS 22 of the session ID.

Furthermore, the Web service application 4A calls the procedural COBOL application 5A onto the same thread 21 “Y”. Furthermore, the RTS 22 restores the resource 5B corresponding to the received session ID, for the procedural COBOL application 5A on the thread 21 “Y”. Furthermore, when the execution of the procedural COBOL application 5A on the same thread 21 “Y” is completed, the Web service application 4A requests the RTS 22 to update the session ID used for identifying the session of the second request “2” that is a current request. Furthermore, the RTS 22 retreats the resource 5B of the procedural COBOL application 5A on the thread 21 “Y”, updates the session ID of an update request, and re-notifies the Web service application 4A of the session ID. Furthermore, the Web service application 4A notifies the Web service client application 3A of the updated session ID.

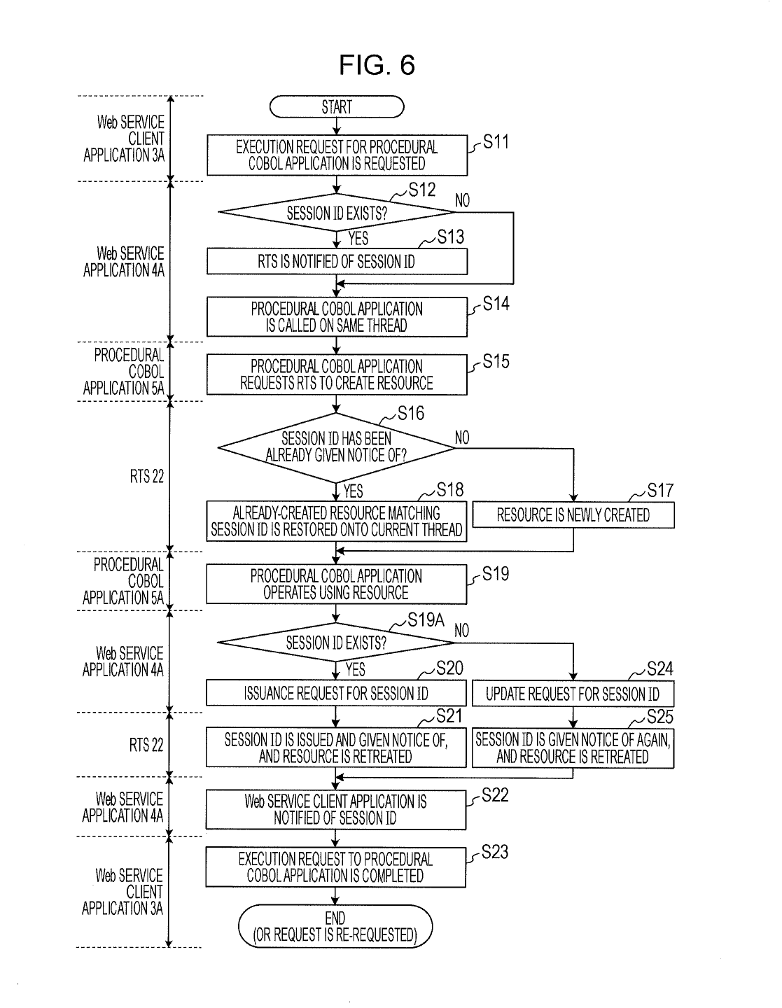

FIG. 6 is a flowchart illustrating the processing operation of the whole Web service application. In FIG. 6, the Web service client application 3A requests, from the server 1A, an execution request of the procedural COBOL application 5A (S11). The Web service application 4A executed on the thread 21 in the server 1A determines whether or not the session ID exists (S12).

When the session ID exists (S12: YES), the ID notification unit 43 in the Web service application 4A notifies the RTS 22 of the session ID (S13). Furthermore, the COBOL calling unit 41 in the Web service application 4A calls the procedural COBOL application 5A onto the same thread 21 (S14).

The procedural COBOL application 5A requests the RTS 22 to create the resource 5B to be used by the procedural COBOL application 5A itself (S15). The RTS 22 determines whether or not the session ID has been already given notice of (S16). When the session ID has not been given notice of yet (S16: NO), the resource creation unit 63 in the RTS 22 creates the new resource 5B on the thread 21 on the procedural COBOL application 5A side (S17).

In addition, when the session ID has been already given notice of (S16: YES), the resource restoration unit 62 in the RTS 22 restores the already-created resource 5B matching the session ID, onto the thread 21 on the procedural COBOL application 5A side (S18). With respect to the procedural COBOL application 5A, the execution processing of the procedural COBOL application 5A utilizing the resource 5B is completed (S19). Furthermore, when the execution processing of the procedural COBOL application 5A is completed, the Web service application 4A determines whether or not the session ID exists (S19A).

When the session ID does not exist (S19A: NO), the ID issuance request unit 42 in the Web service application 4A determines a new request, and requests the RTS 22 to issue a session ID used for identifying a session to be used by the request (S20). When having received the issuance request for the session ID, the session ID issuing unit 52 in the RTS 22 issues the session ID, and notifies the Web service application 4A of the session ID. Furthermore, the resource retreat unit 64 in the RTS 22 retreats the resource 5B used by the procedural COBOL application 5A (S21). In addition, when having retreated the resource 5B, the resource retreat unit 64 manages the resource 5B in the resource management unit 53, with associating the resource 5B with the session ID used for identifying the session of the corresponding request.

When having received the session ID from the RTS 22, the Web service application 4A notifies the web service client application 3A of the session ID (S22). In addition, the Web service client application 3A completes an execution request to the procedural COBOL application 5A (S23), and terminates the processing operation.

When the session ID exists (S19A: YES), the Web service application 4A requests the RTS 22 to update the session ID (S24). In addition, the resource retreat unit 64 in the RTS 22 retreats the resource 5B used by the COBOL application 5A, updates the session ID, re-notifies the Web service application 4A of the session ID (S25), and shifts to S22.

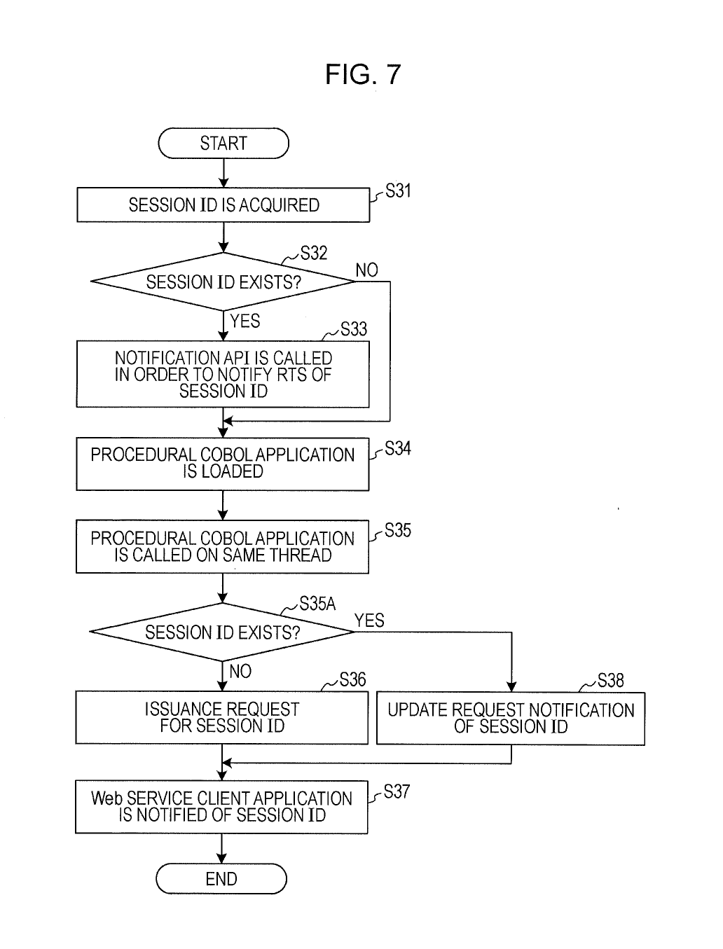

FIG. 7 is a flowchart illustrating the processing operation of the Web service application 4A. In FIG. 7, the Web service application 4A acquires a session ID (S31), and determines whether or not the session ID exists (S32). When the session ID exists (S32: YES), the ID notification unit 43 in the Web service application 4A calls a notification API used for notifying the RTS 22 of the session ID (S33).

The COBOL calling unit 41 in the Web service application 4A loads the procedural COBOL application 5A (S34), and calls the procedural COBOL application 5A onto the same thread 21 (S35). Furthermore, the ID issuance request unit 42 in the Web service application 4A determines whether or not the session ID has already been issued (S35A). When the session ID has not been issued yet (S35A: NO), the ID issuance request unit 42 requests the RTS 22 to issue the session ID used for identifying the session that has been used for the request (S36).

When having received the session ID corresponding to the issuance request for the session ID, the ID notification unit 43 in the Web service application 4A notifies the Web service client application 3A of the session ID (S37), and terminates the processing operation. In addition, when the session ID has already been issued (S35A: YES), the ID notification unit 43 in the Web service application 4A requests the RTS 22 to update the session ID (S38), and shifts to S37.

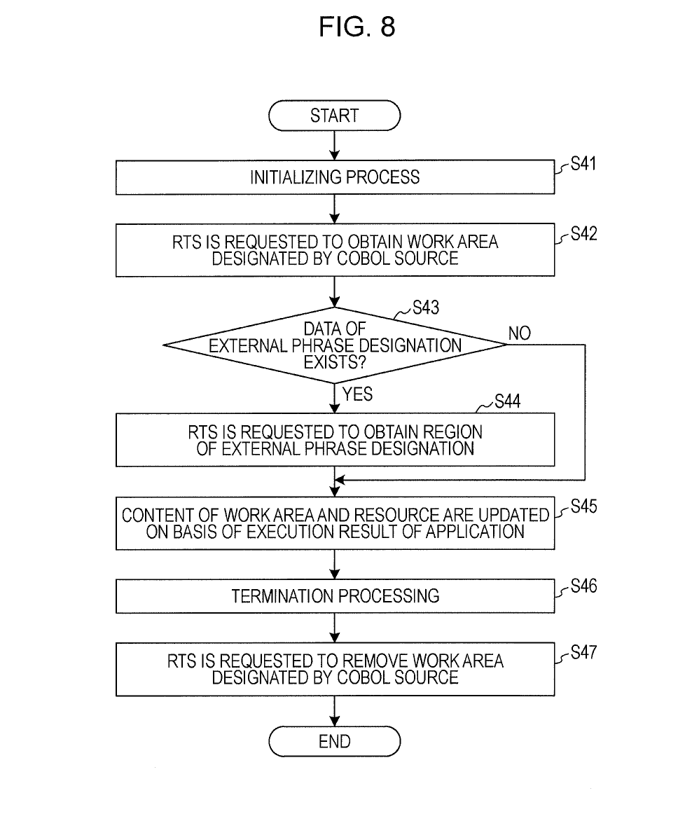

FIG. 8 is a flowchart illustrating the processing operation of the procedural COBOL application 5A. In FIG. 8, the procedural COBOL application 5A executes an initializing process in response to the call operation of the Web service application 4A (S41), and request the RTS 22 to obtain a work area designated by a COBOL source (S42). The procedural COBOL application 5A determines whether or not the data of EXTERNAL phrase designation exists (S43). When the data of the EXTERNAL phrase designation exists (S43: YES), the procedural COBOL application 5A requests the RTS 22 to obtain the region of the EXTERNAL phrase designation (S44).

The procedural COBOL application 5A executes an operation processing according to the request, and updates the content of the work area and the resource 5B on the basis of the execution result thereof (S45), and executes a termination processing so as to complete the execution processing (S46). When executing the termination processing, the procedural COBOL application 5A requests the RTS 22 to remove the work area designated by the COBOL source (S47), and terminates the processing operation.

In addition, when the data of the EXTERNAL phrase designation does not exist (S43: NO), the procedural COBOL application 5A shifts to S45 so as to execute the operation processing according to the request.

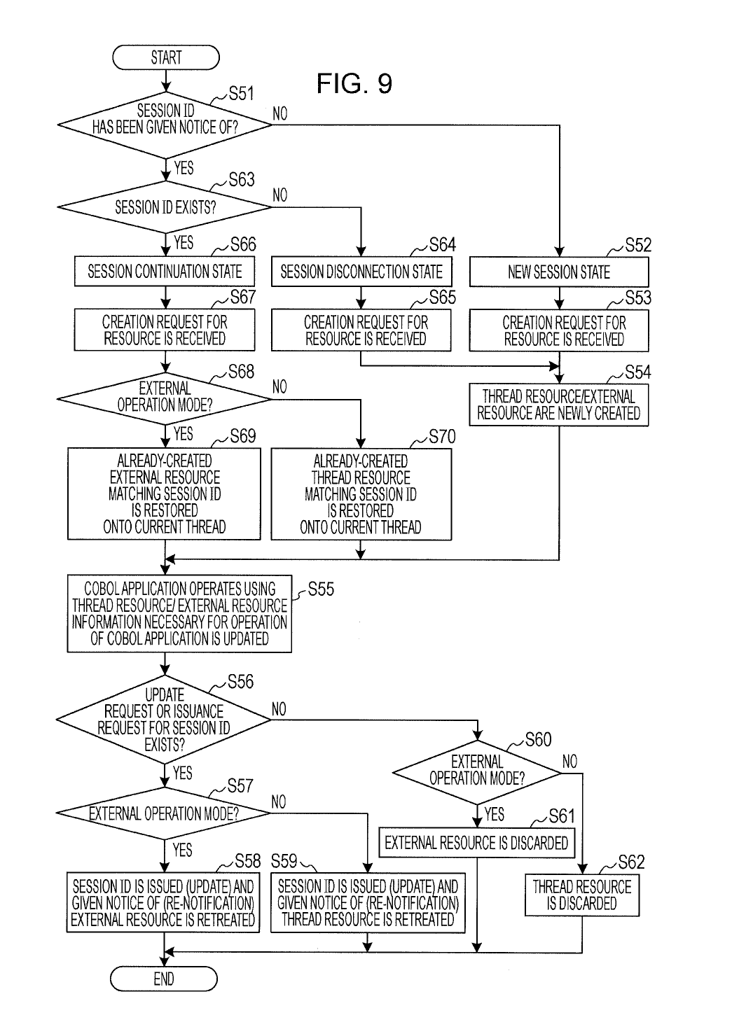

FIG. 9 is a flowchart illustrating the processing operation of the RTS 22. In FIG. 9, the RTS 22 determines whether or not the session ID has been received from the Web service application 4A (S51). When the session ID has not been received (S51: NO), the RTS 22 determines a new session state (S52). After determining the new session state, when the resource creation unit 63 in the RTS 22 receives the creation request for the resource 5B from the procedural COBOL application 5A (S53), the resource creation unit 63 newly creates the thread resource/EXTERNAL resource (S54).

When having newly created the thread resource/EXTERNAL resource, the RTS 22 updates necessary information in response to the execution processing of the procedural COBOL application 5A (S55), and determines whether or not an issuance request or update request for the session ID has been received (S56). When the issuance request or update request for the session ID has been received (S56: YES), the RTS 22 determines whether or not an EXTERNAL operation mode is set (S57).

When the EXTERNAL operation mode is set (S57: YES), the session ID issuing unit 52 in the RTS 22 issues the session ID in response to the issuance request, and notifies the Web service application 4A of the session ID (S58). In addition, when the EXTERNAL operation mode is set (S57: YES), the session ID issuing unit 52 updates the session ID in response to the update request, and re-notifies the Web service application 4A of the session ID (S58). Furthermore, the resource retreat unit 64 in the RTS 22 retreats the EXTERNAL resource that has been used by the procedural COBOL application 5A (S58), and terminates the processing operation. In addition, the resource management unit 53 manages the retreated EXTERNAL resource with associating the retreated EXTERNAL resource with the session ID.

In addition, when the EXTERNAL operation mode is not set (S57: NO), the session ID issuing unit 52 in the RTS 22 issues the session ID in response to the issuance request, and notifies the Web service application 4A of the session ID (S59). In addition, when the EXTERNAL operation mode is not set (S57: NO), the session ID issuing unit 52 updates the session ID in response to the update request, and re-notifies the Web service application 4A of the session ID (S59). Furthermore, the resource retreat unit 64 in the RTS 22 retreats the thread resource that has been used for the procedural COBOL application 5A (S59), and terminates the processing operation. In addition, the resource management unit 53 manages the retreated thread resource with associating the retreated thread resource with the session ID.

In addition, when having received no issuance request or no update request for the session ID (S56: NO), the RTS 22 determines whether or not the EXTERNAL operation mode is set (S60). When the EXTERNAL operation mode is set (S60: YES), the resource providing unit 51 in the RTS 22 discards the EXTERNAL resource (S61), and terminates the processing operation. In addition, the resource management unit 53 discards the EXTERNAL resource and the session ID thereof.

In addition, when the EXTERNAL operation mode is not set (S60: NO), the resource providing unit 51 in the RTS 22 discards the thread resource (S62), and terminates the processing operation. In addition, the resource management unit 53 discards the thread resource and the session ID thereof.

In addition, when having received the session ID from the Web service application 4A (S51: YES), the resource determination unit 61 in the RTS 22 determines whether or not the session ID exists within the resource management unit 53 (S63). When the session ID does not exist within the resource management unit 53 (S63: NO), the resource determination unit 61 in the RTS 22 determines a session disconnection state (S64). After having determined the session disconnection state, when the RTS 22 have received the creation request for the resource 5B from the procedural COBOL application 5A (S65), the RTS 22 shifts to S54 so as to newly create the thread resource/EXTERNAL resource.

In addition, when the session ID exists within the resource management unit 53 (S63: YES), the resource determination unit 61 in the RTS 22 determines a session continuation state (S66). After having determined the session continuation state, when the RTS 22 has received the resource creation request from the COBOL application 5A (S67), the RTS 22 determines whether or not the EXTERNAL operation mode is set (S68).

When the EXTERNAL operation mode is set (S68: affirmative), the resource restoration unit 62 in the RTS 22 restores an EXTERNAL resource, which has been created and matches the session ID managed by the resource management unit 53, onto the current thread 21 (S69), and shifts to S55. In addition, when the EXTERNAL operation mode is not set (S68: NO), the resource restoration unit 62 in the RTS 22 restores a thread resource, which has been created and matches the session ID managed by the resource management unit 53, onto the current thread 21 (S70), and shifts to S55.

In the second embodiment, when having received a request for executing the procedural COBOL application 5A from the Web service client application 3A, the thread 21 in which the Web service application 4A is executed is assigned with respect to each corresponding request. Furthermore, in the second embodiment, the procedural COBOL application 5A is called onto the assigned thread 21, and the resource 5B to be used is provided to the procedural COBOL application 5A in response to the resource request from the procedural COBOL application 5A. As a result, even if the procedural COBOL application 5A is called, as a Web service, from the Web service client application 3A, it is possible to respond to a stable multi-thread method.

In the second embodiment, when the execution processing of the procedural COBOL application 5A has been completed, the session ID of the session used by the request is issued, and the resource 5B that has been used for the corresponding procedural COBOL application 5A is retreated. Furthermore, the retreated resource 5B is managed in the resource management unit 53 with being associated with the session ID. As a result, even if a plurality of requests have been received from the Web service client application 3A, it is possible to take over the same resource 5B between continued requests.

Furthermore, when the resource 5B corresponding to the session ID of the session relating to a request exists at the time of the reception of the request, the corresponding resource 5B is restored onto the procedural COBOL application 5A. As a result, it is possible to take over the same resource 5B between continued requests.

Furthermore, when the resource 5B corresponding to the session ID of the session relating to a request does not exist at the time of the reception of the request, the resource 5B is newly created on the procedural COBOL application 5A.

Furthermore, in the second embodiment, when the session ID has been issued on the RTS 22 side, the Web service client application 3A is notified of the session ID. As a result, when continued requests are executed, it is possible to take over the resource 5B corresponding to the session ID between requests, using the corresponding session ID.

Furthermore, in the second embodiment, when the EXTERNAL resource that is the resource 5B is provided to the procedural COBOL application 5A at the time of the EXTERNAL mode, the EXTERNAL resource is managed in the resource management unit 53 with being associated with the session ID.

Furthermore, when the thread resource that is the resource 5B is provided to the procedural COBOL application 5A at the time of a normal mode that is not the EXTERNAL mode, the thread resource is managed in the resource management unit 53 with being associated with the session ID.

In addition, the individual configuration elements of the individual portions illustrated in figures are not necessarily configured as physically illustrated in figures. Namely, a specific embodiment of the distribution or integration of the individual portions is not limited to one of examples illustrated in figures, all or part of the individual portions may be functionally or physically integrated or distributed in arbitrary units according to various loads and various statuses of use and configured.

Furthermore, all or arbitrary part of the various kinds of processing functions performed in the individual devices may be executed on a central processing unit (CPU) (alternatively, a micro computer such as a micro processing unit (MPU), a micro controller unit (MCU), or the like). In addition, it should be understood that all or arbitrary part of the various kinds of processing functions may be executed on a program, analyzed and executed by a CPU (alternatively, a micro computer such as an MPU, an MCU, or the like), or on hardware based on wired logic.

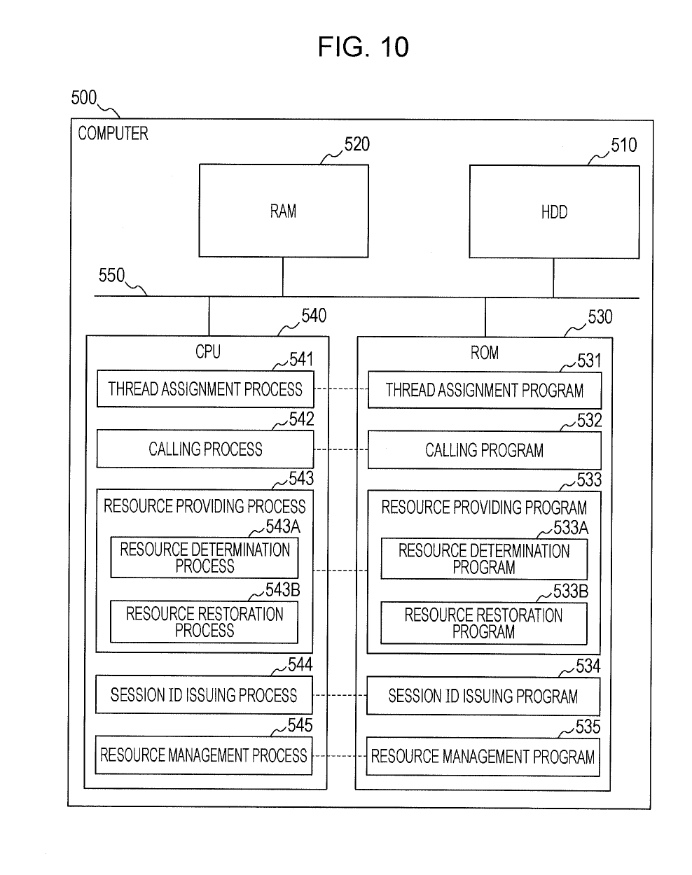

Incidentally, various kinds of processing described in the first embodiment and the second embodiment may be realized by causing a computer to execute a preliminarily prepared program. Therefore, hereinafter, using FIG. 10, an example of a computer that executes a program having the same functions as those of the above-mentioned embodiments will be described.

As illustrated in FIG. 10, a computer 500 includes a hard disk drive (HDD) 510, a random access memory (RAM) 520, a read only memory (ROM) 530, and a CPU 540, which are connected to one another through a bus 550, and is configured.

In addition, a program fulfilling the same functions as those of the above-mentioned embodiments is preliminarily stored in the ROM 530. The program includes a thread assignment program 531, a calling program 532, a resource providing program 533, a session ID issuing program 534, and a resource management program 535. Furthermore, the resource providing program 533 includes a resource determination program 533A and a resource restoration program 533B. In addition, the programs 531 to 535 may be arbitrarily integrated or distributed in the same way as the individual configuration elements of the server 1 illustrated in FIG. 1.

In addition, the CPU 540 reads out and executes the programs 531 to 535 from the ROM 530, and hence the individual programs 531 to 535 turn out to function as various kinds of processes. The various kinds of processes include a thread assignment process 541, a COBOL calling process 542, a resource providing process 543, a session ID issuing process 544, and a resource management process 545. Furthermore, the resource providing process 543 includes a resource determination process 543A and a resource restoration process 543B. The individual processes 541 to 545 correspond to the thread assignment unit 11, the calling unit 12, the resource providing unit 13, the resource determination unit 13A, the resource restoration unit 13B, the session ID issuing unit 14, and the resource management unit 15, illustrated in FIG. 1, respectively.

When having received a request for the execution of an application from a client, the CPU 540 assigns a thread with respect to each corresponding request. Furthermore, the CPU 540 calls the application onto the assigned thread. Furthermore, in response to a resource request from the application, the CPU 540 provides a resource to be used by the application to the corresponding application. Furthermore, the CPU 540 issues a session ID used for identifying a session that has been used for the request.

Furthermore, when the execution processing of the application on the thread is completed, the CPU 540 retreats the resource used by the corresponding application from the thread. Furthermore, the CPU 540 manages the retreated resource with associating the retreated resource with the session ID used for identifying the session used by the corresponding request. Furthermore, when the CPU 540 has received the session ID of the session used by the corresponding request in providing the resource in response to the resource request from the application, the CPU 540 determines whether or not a resource corresponding to the corresponding session ID exists. Furthermore, when the resource corresponding to the session ID exists, the CPU 540 restores the corresponding resource onto the application relating to the corresponding request.

As a result, even if a plurality of requests are received from a client in each of different sessions, it is possible to take over a same resource between a plurality of continued requests that have used a same session.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a program causing a computer to execute a process, the process comprising:
assigning, to a thread, a processing that is specified by a program described with a procedural language and requested by a received processing request;
reading out the thread resource stored with being associated with identification information for identifying a session used for communication relating to the processing request, from a storage unit in which identification information for identifying a session and the thread resource are stored with being associated with each other; and
executing the processing assigned to the thread by using the read out thread resource.

2. The computer-readable, non-transitory medium according to claim 1, the process further comprising:
after the termination of the processing, storing the thread resource in the storage device with associating the thread resource with the identification information for identifying the session used for communication relating to the processing request.

3. The computer-readable, non-transitory medium according to claim 1, the process further comprising:
newly creating the thread resource when the identification information for identifying the session used for communication relating to the processing request is not stored in the storage device.

4. The computer-readable, non-transitory medium according to claim 1,
wherein when the thread resource used for processing in a source program of the application is designated, executing the processing by using the designated thread resource.

5. A resource management device comprising:
a thread assignment unit configured to assign, to a thread, a processing that is specified by a program described with a procedural language and requested by a received processing request;
a storage unit configured to store therein identification information for identifying a session and a thread resource with associating the identification information with the thread resource;
a resource providing unit configured to read out the stored thread resource associated with the identification information for identifying a session used for communication relating to the processing request, from the storage unit; and
a processing unit configured to execute the processing assigned to the thread by using the stored thread resource.

6. A resource management method comprising:
assigning, to a thread, a processing that is specified by a program described with a procedural language and requested by a received processing request;
reading out, by a computer, the thread resource stored with being associated with identification information for identifying a session used for communication relating to the processing request, from a storage unit in which identification information for identifying a session and the thread resource are stored with being associated with each other; and
executing the processing assigned to the thread by using the read out thread resource.
